(19) United States
(12) Patent Application Publication
(10) Pub. No.: US 2009/0263685 A1
(43) Pub. Date: Oct. 22, 2009

(54) METHOD AND SYSTEM FOR FEEDBACK CONTROLLING/CONTROLLING A TOTAL AIR FUEL RATIO OF A REFORMER

(75) Inventors: Jeremy Lawrence, Dresden (DE); Stefan Kading, Zerrenthin (DE); Su Zhou, Shanghai (CN); Norbert Gunther, Ribnitz Damgarten (DE)

Correspondence Address: DICKINSON WRIGHT PLLC, 1875 Eye Street, NW, Suite 1200, WASHINGTON, DC, 20006, US

(73) Assignee: ENERDAY GmbH, Stockdorf (DE)

(21) Appl. No.: 12/440,229

(22) PCT Filed: Aug. 3, 2007
(86) PCT No.: PCT/DE2007/001383

§ 371 Date: Mar. 5, 2009

(30) Foreign Application Priority Data
Sep. 15, 2006 (DE) 10 2006 043 350.

(51) Int. Cl. H01M 8/06

(52) U.S. Cl. 429/17; 429/20

(57) ABSTRACT

The invention relates to a method for closed/open loop control of a total lambda value of a reformer (10) comprising at least a combustion zone (12) and an evaporation zone (14) connected to the combustion zone (12). In accordance with the invention for closed/open loop control of the total lambda value, closed loop control of the lambda value of the combustion zone (12) and open loop control of the fuel performance supplied to the evaporation zone (14) is provided.

The invention relates furthermore to a system with a reformer (10) comprising at least a combustion zone (12) and an evaporation zone (14) connected to the combustion zone (12) and with a a controller (26) for closed/open loop control of a total lambda value. In accordance with the invention the controller (26) is suitable for closed/open loop control of the total lambda value by closed loop control of the lambda value of the combustion zone (12) and open loop control of the fuel performance supplied to the combustion zone (12) and the evaporation zone (14) each.

The invention relates to a method for feedback controlling/controlling a total air fuel ratio—in other words, closed/open loop control of a total lambda value—of a reformer comprising at least a combustion zone and an evaporation zone connected to the combustion zone.

The invention relates furthermore to a system with a reformer comprising at least one combustion zone and an evaporation zone connected to the combustion zone and with a controller for closed/open loop control of a total lambda value.

In fuel cell systems, particularly in SOFC fuel cell systems, it is usually so that reformers are employed which form from a supply of oxidant, particularly air, and fuel hydrogen rich gas mixtures and reformates respectively. For instance, such a reformer may comprise a combustion zone respectively an oxidation zone and an evaporation zone respectively a mixture formation zone connected to the combustion zone. The combustion zone usually receives a supply of air and fuel, resulting in an exothermic reaction of the gas mixture making use of the fuel and air, whereas in the evaporation zone there is a further injection of fuel to support evaporation of the gas mixture. In addition, such reformers usually comprise a catalyst respectively reforming zone connected to the combustion zone at least via the evaporation zone where the gas mixture is subjected to an endothermic reaction. More particularly, the combustion zone receives a supply of fuel from a fuel pump and combustion air from a blower, the combustion zone also being capable of receiving a supply of fuel via a further fuel pump. Open loop control of the two pumps and the blower is mostly done such that in reforming operation of the reformer a total lambda value in the range 0.385 to 0.465 and operating temperatures in the range 850° C. to 900° C. are maintained. Reforming operation outside of the aforementioned total lambda value range can result in the system becoming sooted up, for example when the lambda value is too small, the gas concentrations are too low or the component temperatures too high. This can result in the efficiency being strongly reduced, likewise resulting in a reduction in the efficiency of the fuel cell system. In addition to this, circumstances may result in shortening of the useful life of the components and thus of the fuel cell system as a whole. This is why closed loop control of the total lambda value is usually suitably provided during operation of the reformer depending on the mode of operation (start-up, normal operation, etc). In prior art, closed loop control of the total lambda value is done by a wideband lambda sensor to permit performing suitable closed loop control from having sensed the total lambda value existing in the reformer. Employing such a wideband lambda sensor is unfortunately a very expensive solution to closed loop control of the total lambda value of the reformer.

The invention is thus based on the object of sophisticating generic methods and systems for closed/open loop control of a total lambda value of a reformer such that as compared to prior art this can now be done cost-effectively.

The method in accordance with the invention is a sophistication over generic prior art in that for closed/open loop control of the total lambda value, closed loop control of the lambda value of the combustion zone and open loop control of the fuel performance supplied to the evaporation zone is provided, although it is just as possible that closed loop control of the feed fuel performances instead of open loop control is provided. Closed/open loop control respectively monitoring the total lambda value of the reformer on the basis of closed loop control of the lambda value of just the combustion zone and on the basis of open loop control respectively pilot control of the fuel performances can be implemented in accordance with the following formulae:

$$\frac{{λ}_{Ref}}{{λ}_{Ref}^{oxi}} = \frac{1}{1 + {k}_{p}} = \frac{{P}_{oxi}}{{P}_{ref}} , {k}_{p} = \frac{{P}_{vap}}{{P}_{oxi}} und {P}_{vap} {P}_{ref} - {P}_{oxi} ,$$

where λ_{Ref} is the total lambda value of the reformer, λ_{Ref}^{oxi} is the lambda value of the combustion zone of the reformer, kₚ is the ratio of the fuel performance Pᵥₐₚ supplied by a fuel pump assigned to the evaporation zone, to a fuel performance Pₒₓᵢ supplied by a fuel pump assigned to the combustion chamber and P_{ref} is the total fuel performance of the reformer. By closed loop control of the lambda value of the combustion zone in accordance with the above formulae, for example by sensing the lambda value existing in the combustion zone, with the ratio of both fuel performances being predefined, the total lambda value of the reformer can be obtained. This is now done, however, without sensing the total lambda value of the reformer in thus eliminating the need of a wideband lambda sensor. Accordingly, the method in accordance with the invention makes a cost-effective means of closed/open loop control available which, particularly in automotive SOFC applications is a preferred cost-saving achievement.

The method in accordance with the invention can be further sophisticated to advantage in that closed loop control of the lambda value of the combustion zone is done by sensing the lambda value of the combustion zone and setting the supply of combustion air to the combustion zone. Preferably the existing respectively sensed lambda value of the combustion zone is sensed by a simple sensor, for instance, a lambda sensor.

Furthermore, the method in accordance with the invention may be configured so that the combustion air feed is performed by a combustion air blower assigned to the combustion zone. In this arrangement the combustion air blower blows air directly into the combustion zone which then gains access to the evaporation zone.

In addition, the method in accordance with the invention can be achieved such that closed loop control of the lambda value of the combustion zone is performed by a PID controller. In this arrangement the PID controller (PID transfer element) functions as the means for closed loop control of the lambda value of the combustion zone in achieving closed loop control by activating/setting the combustion air blower.

It is likewise of advantage to sophisticate the method in accordance with the invention so that the fuel performance supplied to the combustion zone and evaporation zone is delivered by a fuel pump assigned to the combustion zone and evaporation zone respectively. In this arrangement the fuel performance supplied to the combustion zone and evaporation zone can be determined, for example, by specifically activating the fuel pumps and activating the feed fuel flow. For example, the fuel performance can be established by determining the calorific value Hᵤ(Hᵢ) of the fuel so that by making use of a certain calorific value activating the pump and the required fuel performance are associated.

In this context the method in accordance with the invention can be realized in that open loop control of the fuel pump assigned to the combustion zone and of the fuel pump assigned to the evaporation zone is provided each on the basis of characteristics. These characteristics involve, for example, information as to the nature of activation and the feed fuel flow supplied by this activation. In this arrangement translating activation into the wanted fuel performance may be performed by characteristic-based transfer elements, the characteristics being obtained from prior sensing results or empirically or, for example, as specified by the pump manufacturer concerned.

The method in accordance with the invention may be furthermore sophisticated so that a command variable for closed loop control of the lambda value of the combustion zone and corresponding reference variables for open loop control of each fuel performance supply are defined by a calculator which in an IT sense may be a setpoint or command/reference variable generator

In this context it is of advantage to achieve the method in accordance with the invention so that the calculator calculates the command variable and each reference variable at least on the basis of sensed data correlating to the operating conditions of the reformer and/or of the fuel cell system. For example, the sensed data may stem from various components of the fuel cell system as relevant to operation of the reformer, although it is just as possible that the sensed data covers further quantities sensed in the reformer affecting its operating condition.

Furthermore, the method in accordance with the invention can be applied so that on the basis of a ratio of the fuel performance supplied to the combustion zone and to the evaporation zone and on the basis of the lambda value of the combustion zone the calculator can conclude the total lambda value and define the command variable and the reference variables on the basis of the sensed data and/or the total lambda value.

The system in accordance with the invention is a sophistication over generic prior art in that the controller is suitable for closed/open loop control of the total lambda value by closed loop control of the lambda value of the combustion zone and open loop control of the fuel performance supplied to the combustion zone and the evaporation zone each. This results in the properties and advantages as explained in conjunction with the method in accordance with the invention to the same or similar degree and thus reference is made to the comments in this respect as to the method in accordance with the invention to avoid tedious repetition.

The same goes for the preferred embodiments of the system in accordance with the invention and, here again, reference is made to the comments in this respect as to the method in accordance with the invention to avoid tedious repetition.

The system in accordance with the invention can be sophisticated to advantage in that the controller is suitable to provide closed loop control of the lambda value of the combustion zone by capturing an existing lambda value of the combustion zone and by setting a supply of combustion air to the combustion zone.

Furthermore, the system in accordance with the invention may be engineered so that the controller is suitable to provide combustion air feed by a combustion air blower assigned to the combustion zone.

In addition, the system in accordance with the invention can be achieved so that the controller comprises a PID controller suitable for providing closed loop control of the lambda value of the combustion zone.

The system in accordance with the invention can be provided for to advantage such that the controller is suitable to perform supply of the fuel performance fed to the combustion zone and evaporation zone each by a fuel pump assigned to each combustion zone and evaporation zone.

In this context it is of advantage that the controller is suitable to provide open loop control of the fuel pump assigned to the combustion zone and of the fuel pump assigned to the evaporation zone each on the basis of characteristics.

Furthermore, the system in accordance with the invention can be realized so that the controller comprises a calculator suitable to define a command variable for closed loop control of the lambda value of the combustion zone and corresponding reference variables for open loop control of the supply of fuel performance.

In this context it is particularly of advantage to sophisticate the system in accordance with the invention such that the calculator is suitable to calculate the command variable and each reference variable at least on the basis of sensed data.

It may furthermore be provided for that the system in accordance with the invention is engineered so that on the basis of a ratio of the fuel performance supplied to the combustion zone and to the evaporation zone and on the basis of the lambda value of the combustion zone the calculator can conclude the total lambda value and define the command variable and the reference variables on the basis of the sensed data and/or the total lambda value.

The invention will now be detailed by way of particularly preferred embodiments with reference to the attached drawings in which:

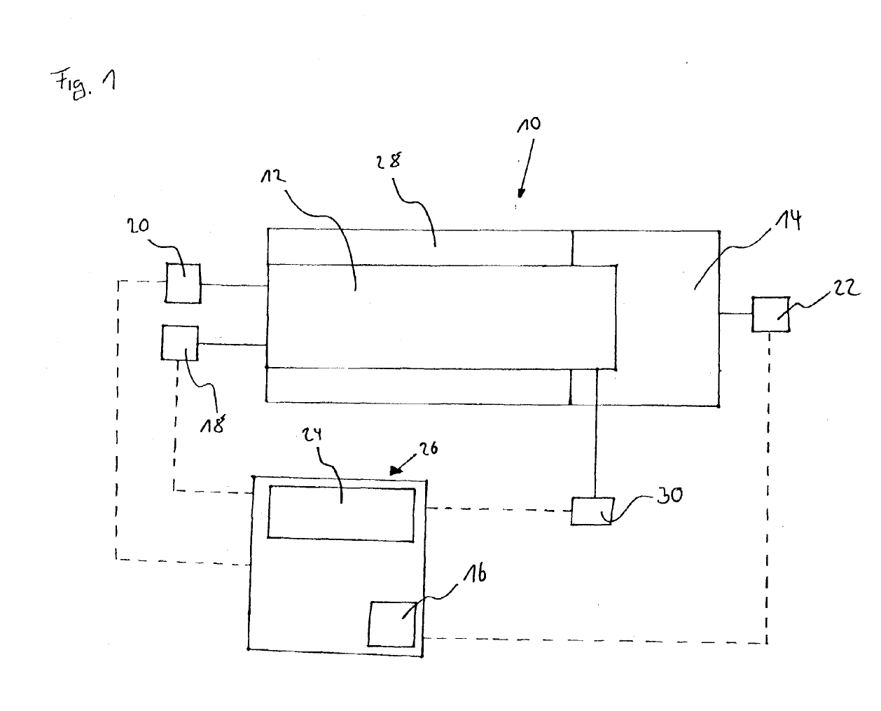

FIG. 1 is a diagrammatic representation of a reformer associated with the system in accordance with the invention; and

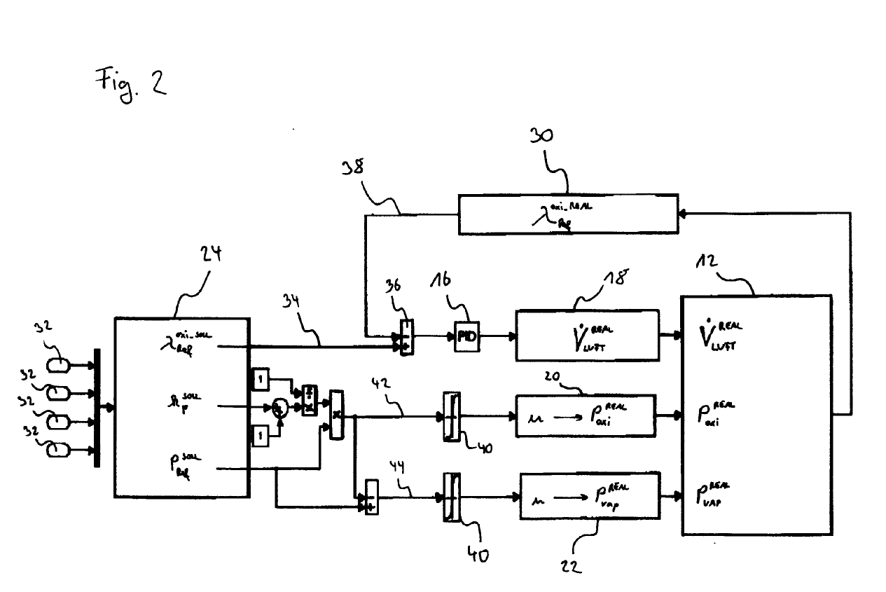

FIG. 2 is a block diagram for performing the method in accordance with the invention.

Referring now to FIG. 1 there is illustrated a diagrammatic representation of a reformer 10 associated with the system in accordance with the invention. The system may include components of no immediate interest and thus not shown, such as a fuel cell or fuel cell stack downstream of the reformer 10, an afterburner, etc. In the case as shown in FIG. 1 the reformer 10 comprises a combustion zone 12 for receiving a supply of fuel, preferably Diesel via a fuel pump 20 assigned to the combustion zone 12 and which may also receive a supply of an oxidant respectively combustion air via a combustion air blower 18. A sensor 30, preferably a lambda sensor, is provided to sense an lambda value of the combustion zone 12 and extends at least in part into the combustion zone 12. Furthermore, the reformer 10 comprises connected to the combustion zone 12 an evaporation zone 14 which receives a supply of a mixture of fuel and combustion air from the combustion zone 12. In this arrangement the sensor 30 is located near to the transition between combustion zone 12 and evaporation zone 14. Accordingly, the sensor 30 may also be provided so that the lambda value of the combustion zone 12 is tweaked at least in part or also in addition to the lambda value existing in the evaporation zone 14. The evaporation zone 14 and/or at least in part the combustion zone 12 can also receive a supply of fuel via a further fuel pump 22 assigned to the evaporation zone 14. Furthermore the reformer 10 comprises a catalyst zone 28 directly connected to the evaporation zone 14 and thus to the combustion zone 12 via the evaporation zone 14. In this arrangement the catalyst zone 28 can receive a supply of the mixture from the evaporation zone and which ultimately discharges the reformate generated in the reformer 10 to the fuel cell or fuel cell stack (not shown). Furthermore provided is a controller 26 for closed/open loop control of a total lambda value of the reformer 10. For activating the fuel pumps 20, 22 and the combustion air blower 18 the controller 26 is coupled to each thereof. Furthermore, the controller 26 is coupled to the sensor 30 which thus furnishes the data sensed as to the lambda value of the combustion zone 12 to the controller 26. In this context the controller comprises a PID controller 16 for performing closed loop control of the lambda value of the combustion zone 12 and a calculator 24 for calculating the command variables and reference variables for closed loop control of the lambda value of the combustion zone 12 and for open loop control of the fuel pumps 20, 22 as will now be detailed with reference to FIG. 2.

Referring now to FIG. 2 there is illustrated a block diagram for performing the method in accordance with the invention by means of the controller 26. The method in accordance with the invention firstly makes available the sensed data 32 to the calculator 24. It is from these sensed data 32 as made available that, for example, the operating conditions of the reformer 10 and/or of further components belonging to the fuel cell system are mapped. From this data the calculator 24 can implement the setpoint calculations involving at least one setpoint value (command variable) for the lambda value λ_{Ref}^{oxi}^{_{—}}^{SOLL} of the combustion zone 12, a reference variable such as the setpoint ratio

$${k}_{p}^{SOLL} = \frac{{P}_{vap}^{SOLL}}{{P}_{oxi}^{SOLL}}$$

from the fuel performances of the fuel pump 22 assigned to the evaporation zone 14 and the fuel pump 20 assigned to the combustion zone 12 and a reference value such as the setpoint value for the total fuel performance P_{ref}^{SOLL} of the reformer 10. The command variable for the lambda value λ_{Ref}^{oxi}^{_{—}}^{SOLL} of the combustion zone 12 is forwarded to a comparator or subtractor 36 via a signal path 34 to form the control difference between the command variable for the lambda value λ_{Ref}^{oxi}^{_{—SOLL}} of the combustion zone 12 and a lambda value λ_{Ref}^{oxi}^{_{—REAL}} supplied by a feedback path 38 as referenced or sensed. The control difference is supplied to the PID controller 16 which is a PID transfer element. In accordance with the control difference the PID controller 16 sets the combustion air blower 18 to blow an air flow \dot{V}_{Luft}^{REAL} into the combustion zone 12 of the reformer 10. In addition, the setpoint value for the total fuel performance P_{ref}^{SOLL} of the reformer 10 and the setpoint ratio kₚ^{SOLL} are translated by the formulae

$$\frac{1}{1 + {k}_{p}} = \frac{{P}_{oxi}}{{P}_{ref}} , {k}_{p} = \frac{{P}_{vap}}{{P}_{oxi}} and {P}_{vap} = {P}_{ref} - {P}_{oxi}$$

by way of corresponding transformations and substitutions (performed by adders, subtractors, multipliers, dividers of no immediate interest) each into a setpoint fuel performance Pₒₓᵢ^{SOLL} of the combustion zone 12 in a signal path 42 and into a setpoint fuel performance Pᵥₐₚ^{SOLL} of the evaporation zone 14 in a signal path 44. On the basis of characteristics the transfer elements 40 in signal paths 42 and 44 translate the setpoint fuel performance Pₒₓᵢ^{SOLL} of the combustion zone 12 and the setpoint fuel performance Pᵥₐₚ^{SOLL} of the evaporation zone 14 into signals u each for activating the fuel pump 20 assigned to the combustion zone 12 and the fuel pump 22 assigned to the evaporation zone 14. For example, how activation of the fuel pumps 20, 22 associates with the required fuel performance is given generally by using a calorific value of the fuel. In particular, the activation signal u results in a feed fuel flow being pumped by the corresponding fuel pump 20, 22, from which with the addition of the calorific value, for example by multiplying the feed fuel flow with the corresponding calorific value, the fuel performance as supplied or pumped can be derived. On the basis of these activation signals u each fuel pump 20, 22 then delivers the actual fuel performance Pₒₓᵢ^{REAL} and Pᵥₐₚ^{REAL} into the combustion zone 12 and evaporation zone 14 respectively. By way of the aforementioned feedback path 38 closed loop control of the lambda value of the combustion zone 12 is performed by feedback of the existing lambda value λ_{Ref}^{oxi}^{_{—}}^{REAL} by the sensor 30, repeat closed loop control then being performed by the PID controller 16 on the basis of the control difference in the subtractor 36 Furthermore, the total lambda value of the reformer 10 is then calculated by the signal path 34 on the basis of the formulae

$$\frac{{λ}_{Ref}}{{λ}_{Ref}^{oxi}} = \frac{1}{1 + {k}_{p}} = \frac{{P}_{oxi}}{{P}_{ref}} , {k}_{p} = \frac{{P}_{vap}}{{P}_{oxi}} und {P}_{vap} = {P}_{ref} - {P}_{oxi}$$

by referencing the fuel performance of each fuel pump 20, 22 and by sensing the lambda value of the combustion zone 12. On the basis of this result, and/or of the furnished sensed data 32 setpoint values are calculated anew as a result of which closed/open loop control of the total lambda value in all is possible.

It is understood that the features of the invention as disclosed in the above description, in the drawings and as claimed may be essential to achieving the invention both by themselves or in any combination.

### LIST OF REFERENCE NUMERALS

10 reformer
12 combustion zone
14 evaporation zone
16 PID controller
18 combustion air blower
20 fuel pump
22 fuel pump
24 calculator
26 controller
28 catalyst zone
30 sensor
32 sensed data
34 signal path
36 subtractor
38 feedback path
40 transfer element
42 signal path
44 signal path

1. A method for closed/open loop control of a total lambda value of a reformer comprising at least a combustion zone and an evaporation zone connected to the combustion zone, comprising the steps of:
controlling for closed/open loop of the total lambda value,
controlling closed loop of the lambda value of the combustion zone, and
controlling open loop of the fuel performance respectively supplied to the combustion zone and to the evaporation zone is provided.

2. The method of claim 1, wherein controlling closed loop of the lambda value of the combustion zone is done by sensing the lambda value of the combustion zone and adjusting the supply of combustion air to the combustion zone.

3. The method of claim 2, wherein the combustion air feed is performed by a combustion air blower assigned to the combustion zone.

4. The of claim 1, wherein controlling closed loop of the lambda value of the combustion zone is performed by a PID controller.

5. The method of claim 1, wherein the fuel performance supplied to the combustion zone (12) and evaporation zone (14) in each case is delivered by a fuel pump (20, 22) assigned to the combustion zone (12) and evaporation zone (14) respectively.

6. The method of claim 5, wherein controlling open loop of the fuel pump assigned to the combustion zone and of the fuel pump assigned to the evaporation zone is provided each on the basis of characteristics.

7. The method of claim 1, wherein a command variable for controlling closed loop of the lambda value of the combustion zone and corresponding reference variables for controlling open loop of each fuel performance supply are defined by a calculator.

8. The method of claim 7, wherein the calculator calculates the command variable and each reference variable at least on the basis of sensed data.

9. The method of claim 8, wherein on the basis of a ratio of the fuel performance supplied to the combustion zone (12) and to the evaporation zone (14) and on the basis of the lambda value of the combustion zone (12) the calculator (24) can conclude the total lambda value and define the command variable and the reference variables, on the basis of the sensed data and/or the total lambda value.

10. A system with a reformer comprising at least a combustion zone and an evaporation zone connected to the combustion zone and with a controller for closed/open loop control of a total lambda value of the reformer, wherein the controller is suitable for closed/open loop control of the total lambda value by closed loop control of the lambda value of the combustion zone and open loop control of the fuel performance supplied to the combustion zone and the evaporation zone each.

11. The system of claim 10, wherein the controller is suitable to provide closed loop control of the lambda value of the combustion zone by capturing an existing lambda value of the combustion zone and by adjusting a supply of combustion air to the combustion zone.

12. The system of claim 11, wherein the controller is suitable to provide the combustion air feed by a combustion air blower assigned to the combustion zone.

13. The system of claim 10, wherein the controller comprises a PID controller suitable for providing closed loop control of the lambda value of the combustion zone.

14. The system of claim 10, wherein the controller is suitable to perform supply of the respective fuel performance fed to the combustion zone and to the evaporation zone by a respective fuel pump assigned to the combustion zone and to the evaporation zone.

15. The system of claim 14, wherein the controller is suitable to provide open loop control of the fuel pump assigned to the combustion zone and of the fuel pump assigned to the evaporation zone each on the basis of characteristics.

16. The system of claim 10, wherein the controller comprises a calculator suitable to define a command variable for closed loop control of the lambda value of the combustion zone and corresponding reference variables for open loop control of the supply of the respective fuel performance.

17. The system of claim 16, wherein the calculator is suitable to calculate the command variable and each reference variable at least on the basis of sensed data.

18. The system of claim 17, wherein on the basis of a ratio of the fuel performance supplied to the combustion zone and to the evaporation zone and on the basis of the lambda value of the combustion zone the calculator is suitable to conclude the total lambda value and define the command variable and the reference variables on the basis of the sensed data and/or the total lambda value.
